(19) United States
(12) Patent Application Publication
(10) Pub. No.: US 2005/0028795 A1
(43) Pub. Date: Feb. 10, 2005

(54) Boosting mechanism for internal combustion engines

(76) Inventor: Robert C. Benson, Liverpool, NY (US)

Correspondence Address: BOND, SCHOENECK & KING, PLLC, ONE LINCOLN CENTER, SYRACUSE, NY, 13202-1355, US

(21) Appl. No.: 10/636,873

(22) Filed: Aug. 7, 2003

(51) Int. Cl. H01M 8/04; H01M 8/12; H01M 2/02; F02B 33/00

(52) U.S. Cl. 123/559.1; 429/34; 429/25

(57) ABSTRACT

A supercharger system for an internal combustion model engine is driven by the associated engine and includes a drive belt, a belt driven pulley and a mounting bracket. The pulley drives a shaft, which is connected to the turbo impeller. The impeller is driven at multiple speeds within a volute. The turbo impeller is recessed into an internal housing to provide smooth air flow from the impeller into the volute. The mounting bracket provides flexibility in mounting to various internal combustion model engines. A portion of the supercharger output pressure can be diverted through a hose containing a check valve and used to create positive pressure in a pressurized fuel cell, resulting in consistent and even flow of fuel into the engine's combustion chamber.

### FIELD OF THE INVENTION

This invention relates to a boosting mechanism for use on internal combustion model engines, in particular to a supercharger for an internal combustion model engine and a fuel system boosting mechanism for an internal combustion model engine. As used in this specification, internal combustion model engine refers to a small internal combustion engine designed for use on scale model aircraft, scale model race cars, and small vehicles such as motorcycles, snowmobiles, go-carts, all-terrain vehicles and the like. The present invention enhances the power of model engines.

### BACKGROUND OF THE INVENTION

Generally, an internal combustion model engine draws the air required for driving the engine by the negative pressure created as the engine is driven, which is sometimes referred to as scavenging. Also, fuel for such engines is delivered to the engine either by gravity feed from the fuel cell or by introducing pressure from exhaust gases into a pressurized fuel cell, which forces fuel into the engine.

Engine power output is directly related to the amount of air and fuel provided to the engine. In order to increase the power output of the engine, the amount of air and/or fuel provided to the engine must be increased. In order to make the engine more powerful, a supercharger is connected to an engine. As is known in the art, a supercharger uses a compressor that increases the amount of air available to the engine's combustion cycle and the pressure at which the air is injected into the engine. As is known in the art, a turbocharger is a form of supercharger that uses exhaust gas pressure to drive the compressor.

Internal combustion engines are delivered fuel from a fuel cell in a variety of methods. To increase the power of the engine by increasing the amount of fuel available for combustion, the fuel must be delivered under increased pressure. It is known that one method is to create pressure in the fuel cell in order to push the fuel from the fuel outlet of the fuel cell to the carburetor of the engine.

The fuel cell pressure is often created by channeling a portion of the engine's exhaust gases to the fuel cell. However, as the RPM of the engine changes so does the volume of exhaust gases and exhaust pressure of the engine. The fluctuating exhaust pressure changes the pressure in the fuel cell due to the unrestricted channel used to connect the exhaust to the fuel cell. This pressure fluctuation creates a non-efficient flow of fuel to the carburetor as well as a lag in the engine response due to time required to pressurize the fuel cell to push fuel to the engine.

It is known that the engine response is the time difference between when the throttle body is advanced until the time the engine changes revolutions per minute as well as the time duration to perform the change. The delay in engine response is partly due to the time required for the pressure to build up in the fuel cell in order to supply the engine with the additional fuel from the fuel cell required to increase its revolutions per minute. To increase efficiency, output power and improve throttle response the fuel cell needs to be more consistently pressurized such that fuel can be delivered to the engine immediately as the throttle is advanced.

The fuel cell system that is used in existing model engines restricts the degree to which such an engine can be supercharged. When a supercharging device delivers air under increased pressure to the carburetor of such an engine, the increased air pressure in the carburetor forces fuel out of the carburetor and back toward the fuel cell. This reverse fuel flow occurs when the carburetor intake pressure from the supercharger is greater than the pressure applied to the fuel cell by gravity or as a result of pressure from the exhaust. This causes the engine to receive less than adequate fuel from the fuel cell, reducing the engine output power and efficiency.

The two-stroke supercharger described in U.S. Pat. No. 6,112,709 uses an impeller mounted in front of the intake port of the engine, which has a minimal effect on the draw of additional fuel and thus has a limited ability to increase the working pressure of the gas. First, the impeller is closed in the center, which does not enable the turbo fan to properly function as a pressure generator. It is known that the impeller is more efficient at creating pressure when there is a clearance in the center of the axis of the vanes on the impeller, which enables the vanes to create the negative pressure or draw to the center of its axis. As the air is drawn to the center it is collected by the vanes and pushed into a volute or collecting area around the outside of the impeller and then discharged into a collecting channel.

Second, the inner crankcase disclosed in the '709 patent does not have a supporting structure such as a volute or collecting point or an exit for the pressurized gasses to leave the impeller in a controlled or channeled manner. The result of this is an uncontrollable turbulence in the crankcase of the engine with an inefficient and uncontrolled force into the intake port of the engine.

Third, the impeller disclosed in the '709 patent is directly engaged to the engine's crank shaft and therefore rotates at the same rate as the engine.

Finally, the construction is complicated and difficult to adapt to various types of engines. Each engine manufacturer uses a variety of different parts including the size of the hexagonal one way bearing, different shaft sizes and multiple crankcase end caps for pull start and non-pull start engines. The structure of the boosting mechanism according to the '709 patent must be altered for each different style of engine on which it is to be mounted.

Supercharging model type engines is difficult because such engines cannot function properly with excessive resistance or mass added to their axially rotating parts. When excessive mass or resistance is added to such an engine's axially-rotating parts, the engine's performance characteristics change, degrading the power and reliability of the engine. Such addition of mass or resistance to an engine's axially-rotating parts affects the engine especially during starting and low-RPM idling the engine. At the time of starting the engine the engine is making very little power and if the added mass or resistance is too great the engine will be difficult to start. After the engine starts, too much added mass or resistance causes the engine's low-RPM idling characteristics to degrade and the engine may become less reliable and more likely to stall. It is known that most superchargers used in larger scale applications are of the Roots type, which require more power to turn because of the high friction and mass of the multiple compressor wheels used to generate the additional air to the engine.

### OBJECTS AND SUMMARY OF THE INVENTION

The object of the present invention is to provide a supercharger and fuel-boosting system for an internal combustion model engine, which improves engine output power, efficiency and provides substantial flexibility for installation on small internal combustion engines of different types. Specifically, it is an object of the present invention:
To provide a supercharger with a high-efficiency turbo impeller that maximizes air flow to the engine;
To provide the turbo impeller with a supporting structure that collects the pressurized gasses into a volute and then channels the gases to the exit of the structure;
To provide a supercharger that is easily mountable to a variety of different engines.
To provide a supercharger that is inexpensive to manufacture;
To provide a supercharger constructed of lightweight components to minimize the engine power required to drive the supercharger;
To provide an easily maintained air filter system within the supercharging unit;
To provide an auxiliary pressure output to increase fuel cell pressure and consistency of fuel delivery.

The present invention is directed to a mechanical supercharging and fuel boosting device that comprises a mounting bracket, turbo impeller, impeller housing including a gas collecting area as well as a controlled exit point, an air filter, a drive belt, a belt tensioning device, a pressurized fuel cell, a means of conveying a portion of the supercharger pressure to the fuel cell, and one or more check valves connected in line between the supercharger output and the fuel cell.

A supercharger supplies more air than normally drawn by the engine using scavenging. The fuel boosting channel supplies more gas then normally delivered by using the exhaust pressure to pressurize the fuel cell and push the fuel from the fuel cell to the engine. With the supercharger and fuel-boosting system, the engine ignites more fuel with the increased amount of air and gas delivered to the engine's combustion chamber. This increases the pressure of fuel and air delivered to the intake ports and then to the combustion chamber, increases the working pressure of the air-fuel combination, thus increasing the power output of the engine. Moreover, the supercharger generates consistent positive air pressure whenever the engine is operating and without regard to the speed at which the engine operates. As a result, there is consistent positive pressure in the fuel cell which eliminates the gradual increase in power that is characteristic of exhaust gas pressured systems. It also eliminates the reverse flow of fuel from an over-pressure carburetor, as is characteristic of other fuel supply systems.

### BRIEF DESCRIPTION OF THE DRAWINGS

This invention may be more clearly understood from the following detailed description and by reference to the drawings in which:

FIG. 1 is a front view of the supercharger assembly as mounted on a standard model engine;

FIG. 2 is an exploded view of the supercharger of FIG. 1;

FIG. 3 is a front elevation view of the supercharger of FIG. 1;

FIG. 4 is a sectional view of the supercharger of FIG. 3;

### DETAILED DESCRIPTION OF THE INVENTION

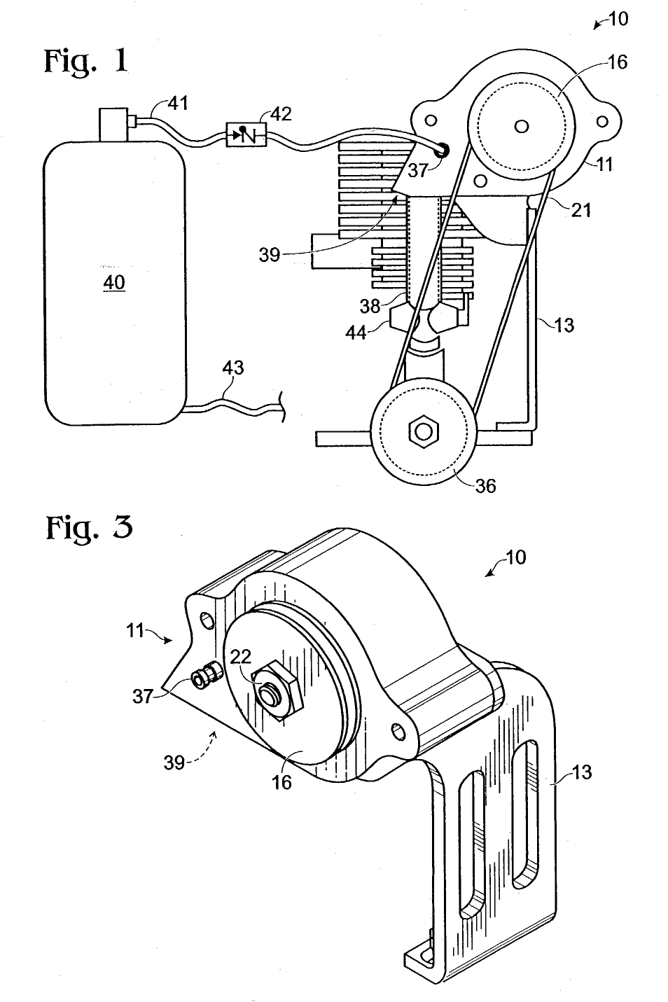

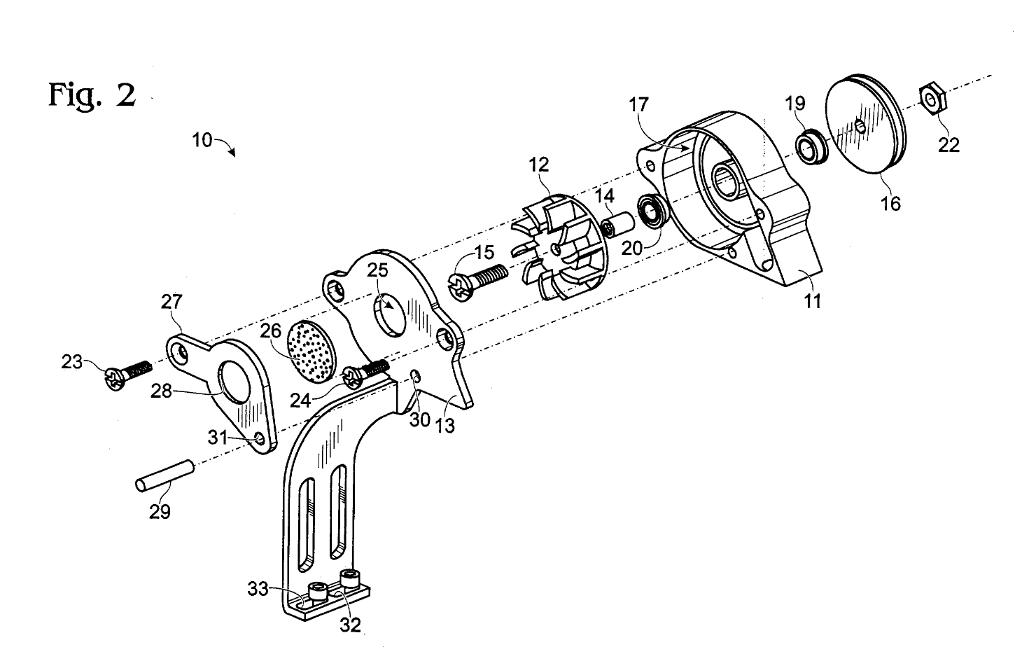

Referring now to FIG. 1, the supercharging device 10 is capable of being mounted on various types of model engines using the slots 34, 35 (FIG. 2) on the engine mounting bracket 13 for alignment. Standard model engines have a mounting flange on each side of the engine. Bolts 32, 33 (FIG. 2) are installed through slots 34, 35 of engine mounting bracket 13 securing supercharger assembly 10 to the given engine mounts. The spacing between the mounting holes 34, 35 varies for different engine types. The slots 34, 35 in the supercharging device's mounting bracket 13, however, allow the supercharging device 10 to be mounted on all standard types of model engines. The slots 34, 35 also allow for front to rear travel to align the drive pulley 16 on the supercharging device 10 to the engine pulley 36. In one embodiment, the standard engine flywheel is replaced with a modified flywheel in which the thickness has been reduced to accept a an engine pulley 36 that is the same thickness by which the flywheel was reduced. This will allow the overall assembly to be the same length as the standard model engine, which is critical for proper function of the engine and supercharger. The drive belt 21 connects the drive pulley 16 to the engine pulley 36, which spins the drive shaft 14 (FIG. 2) that is connected to the turbo impeller 12 (FIG. 2).

Referring now to FIG. 2, as the turbo impeller 12 rotates, it creates a negative pressure draw to the center of its axis. As the air is drawn from outside of the turbo housing 11 to the center of the turbo impeller 12, it passes through the air filter disk 26 in order to prevent debris from entering the supercharger. The air filter disk 26 is easily removed for cleaning and maintenance. The supercharger unit itself takes filtered air in from the center of the impeller 12 which has radial vanes which compress the air over about one full revolution in a volute of increasing area before discharging the air such that the air flows smoothly into the volute with no abrupt drop off to create turbulence. The pressurized air then leaves the volute of the supercharger and is channeled through the output port 39 into the carburetor through the connecting tube 38. The gases pass through the carburetor and then enter the carburetor under pressure and are forced into the intake ports. When the intake port opens, it allows the fresh pressurized charge of air and gas into the combustion chamber. In a two-stroke engine, the pressurized output of the supercharger assists in forcing the exhausted charge out through the exhaust port aiding in the normal scavenging process of the engine.

Referring again to FIG. 1, a portion of the pressurized output of the turbocharger can be channeled from supercharger 10 to a pressurized fuel cell 40 and used to create positive pressure in the fuel cell 40 to increase the amount of fuel introduced into the engine's carburetor. A check valve 42 between the supercharger 10 and the fuel cell 40 prevents loss of pressure from the fuel cell 40 to the supercharger 10 if the relative pressure of the supercharger output falls below the pressure in the fuel cell 40.

In another embodiment, the check valve 42 is used without the supercharging device 10. In such an application, the hose 41 is connected between the engine's exhaust output (not shown) and the fuel cell 40, as is known in the art. As is also known in the art, exhaust-generated air pressure varies directly with an engine's rate of rotation (rpm). Insertion of the check valve 42 between the engine's exhaust output and the fuel cell 40 allows the fuel cell 40 to maintain more even positive pressure by preventing pressure drop from the fuel cell 40 to the engine's exhaust output during periods of low engine rpm.

Referring again to FIG. 2, the supercharger assembly 10 comprises a turbo housing 11, a turbo impeller 12, an engine mounting bracket 13, a drive shaft 14 and a pulley 16. The turbo housing 11 is generally hollow and defines on its inner surface an impeller cavity 17. The impeller cavity 17 is sized and shaped such that the turbo impeller 12 is capable of rotating within the impeller cavity 17 thereby generating positive air pressure at air output port 39 (not shown). The drive shaft 14 extends through a bore (not shown) in a first side of the turbo housing 11. As is known in the art, one or more bearings 19, 20 must be used to reduce friction between the drive shaft 14 and the turbo housing 11. Outside of the turbo housing 11, the drive shaft 14 is fixedly attached to a drive pulley 16. Preferably, the drive pulley 16 has a U-shaped groove at its outer circumference to engage a drive belt 21. Those skilled in the art will recognize that there are a variety of equivalents to this arrangement, including a toothed drive pulley that engages a drive chain. In the preferred embodiment, the engine mounting bracket 13 is attached to the turbo housing 11 using mounting screws 23, 24. Other fasteners can be used in place of mounting screws.

The engine mounting bracket 13 has on its face air intake port 25. In the preferred embodiment, an air filter assembly removes impurities from air flowing into the air intake port 25. The air filter assembly is comprised of an air filter bracket 27 and an air filter disk 26. The air filter disk 26 is preferably manufactured of synthetic mesh fabric encased in a rigid circular frame and is sized slightly larger than the air intake port 25, such that the air filter disk 26 cannot inadvertently pass through the air intake port 25. The air filter disk 26 is also sized to fit within a tiered recess on the back side of air filter bracket 27. In operation, the air filter disk 26 is fixed into position between the air filter bracket 27 and the engine mounting bracket 13. In the preferred embodiment, the air filter mounting bracket is hingedly attached to the engine mounting bracket 13 by mounting screw 23 which passes through the air filter bracket 27 before it passes through the engine mounting bracket 13 and then into the turbo housing 11. After the air filter bracket 27 is rotated in position such that the air filter disk 26 covers the air intake port 25, the air filter bracket 27 is fixed into position with a dowel pin 29 that passes through engine mounting bracket dowel pin bore 30 and is releaseably seated in dowel pin bore 31 in the turbo housing 11.

The engine mounting bracket 13 has a front engine mounting slot 32 and a rear engine mounting slot 33. Engine mounting slots 32, 33 are sized to accommodate screws 34, 35 found on standard internal combustion model engines. The length of engine mounting slots 32, 33 is selected to accommodate screws 34, 35 in the variety of widths found in standard internal combustion model engines.

As is shown in FIG. 1, drive belt 21 engages drive pulley 16 and engine pulley 36. Drive belt 21 is preferably made of rubber. In the preferred embodiment, the drive belt 21 is a rubber O-ring of sufficient durometer that it will not stretch excessively when the supercharger operates at 30,000 to 40,000 rpm. The drive belt 21 must also be made of material that is resistant to alcohol and oil that will be present in the supercharger's operating environment. In one embodiment, a standard engine flywheel is replaced with a modified flywheel (not shown) and engine pulley 36, which are sized to be the same thickness and approximately the same weight as the standard engine flywheel. In another embodiment, engine pulley 36 is a modified version of the flywheel of a standard internal combustion model engine. Specifically, engine pulley 36 is of similar thickness, weight and diameter to a standard flywheel. Engine pulley 36, however, has been modified to include a U-shaped groove on its outer circumference capable of engaging drive belt 21. One skilled in the art will recognize that alternate methods of engagement are possible, including a toothed engine pulley 36 that engages a drive chain.

The rate of rotation of the turbo impeller 11 during operation is determined by the relative diameters of the drive pulley 16 and engine pulley 36. In applications where the supercharging mechanism must generate a relatively higher volume of air, the drive pulley 16 would be sized smaller than the engine pulley 36 causing the turbo impeller 12 to rotate at a higher rate than the engine. Similarly, in applications in which the supercharger is required to generate a smaller volume of air, the drive pulley 16 would be sized to have a larger diameter than the engine pulley 36 causing the turbo impeller 12 to rotate at a slower rate than the engine. Those skilled in the art will recognize that the volume of air generated by the supercharger is selectable by changing the rate of rotation of the turbo impeller 12.

The air pressure generated by rotation of the turbo impeller 12 within the impeller cavity 17 is directed through an air output port 39. Preferably, a connecting tube 38 connects the air output port 39 to the engine's air intake. In typical applications, the connecting tube 38 can be made of vinyl tubing. However, rubber and metal are suitable equivalents. Preferably the connecting tube 38 is flexible to allow easy attachment of the supercharger assembly 10 to the engine, but properly shaped and sized solid materials are suitable equivalents.

In the preferred embodiment, the turbo housing 11 includes an air pressure fitting 37. The air pressure fitting 37 allows a portion of the air generated by the super charger 10 to be diverted from the engine's air intake. In one embodiment of the present invention, a hose 41 containing a check valve 42 connects the air pressure fitting 37 to a fuel cell air inlet 45 on a pressurized fuel cell 40 that provides fuel to the engine. In this way, a portion of the air pressure generated by the super charger 10 passes through the air pressure fitting 37 into the hose 41 and into the pressurized fuel cell 40, increasing the air pressure in the pressurized fuel cell 40. The check valve 42 prevents loss of this pressure to the supercharger 10 in case the engine's rate of speed is reduced, thereby reducing the air pressure output of the supercharger 10. The pressurized fuel cell 40 is thus capable of retaining positive air pressure for a period of time after a reduction in the engine's rate of speed.

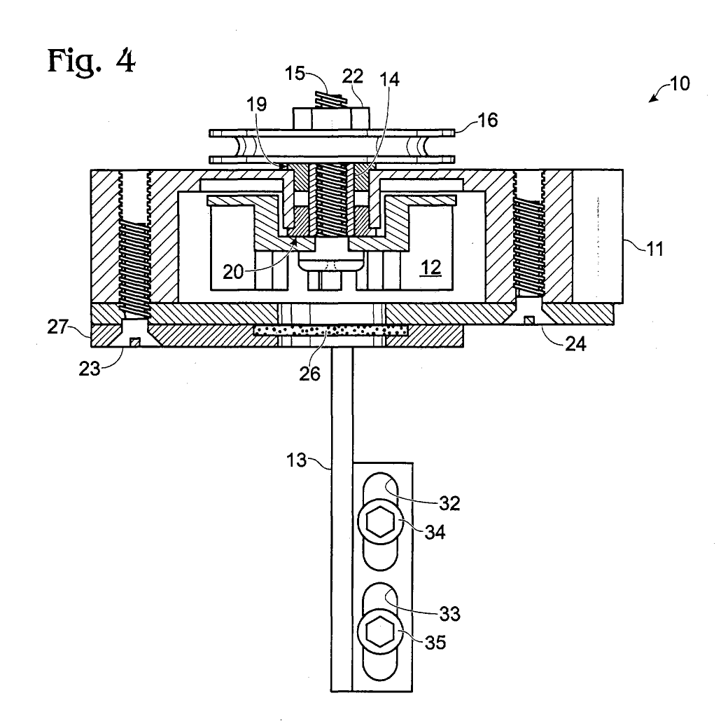

Referring now to FIG. 4, a sectional drawing of FIG. 3 is shown including: Impeller mounting screw 15 is installed through the center of the turbo impeller 12 and secured into drive shaft 14. Inner bearing 20 is then installed to the outer diameter of drive shaft 14. Front bearing 19 is then installed into the housing 11 with drive shaft 14 disposed in the center of the bearing 19. Drive pulley 16 is installed on protruding screw 15 and then secured using pulley mounting nut 22.

Accordingly, the reader will see that the mechanical supercharging device of this invention can be used to increase power and efficiency of an internal combustion engine and can be mounted on multiple engine types. In addition this invention is lightweight which requires minimal power from the engine to drive the supercharger. The supercharger auxiliary pressure fitting can be connected to an existing pressurized fuel system, resulting in increased air pressure in the fuel cell and increased fuel pressure at the engine's fuel intake, which will enhance throttle response and power of the engine.

The above embodiments of the present invention are merely descriptive of its principles and are not to be considered limiting. The scope of the present invention instead shall be determined from the scope of the following claims including their equivalents.

1. A boosted internal combustion model engine, comprising:
a) an internal combustion model engine; and
b) a supercharger, comprising:
i. a turbo housing, having a plurality of sides, an air intake and an air output port;
ii. a turbo impeller located within the turbo housing;
iii. a turbo shaft, a first end of which is fixedly connected to the turbo impeller and a second end of which projects through a side of the turbo housing;
iv. a means for causing the turbo shaft to rotate within the turbo housing, whereby positive air pressure is generated at the air output port; and
v. a means for conveying positive air pressure from the air output port to an air intake of said internal combustion engine.

2. The boosted engine of claim 1, further comprising:
a) a pressurized fuel cell having an air inlet; and
b) means for conveying positive air pressure from the air output port to the air inlet of the pressurized fuel cell.

3. The boosted engine of claim 2, wherein the means for conveying positive air pressure from the air output port to the air inlet of the pressurized fuel cell comprises flexible tubing.

4. The boosted engine of claim 2, wherein the means for conveying positive air pressure from the air output port to the air intake of said engine comprises flexible tubing.

5. The boosted engine of claim 3, wherein the flexible tubing further comprises a one way valve between the air output port and the air inlet of the pressurized fuel cell, such that air flow from the fuel cell air inlet to the air output is prevented.

6. The boosted engine of claim 1, further comprising a filter means.

7. The boosted engine of claim 6 wherein the filter means is attached to the turbo housing air intake.

8. A boosting mechanism for an internal combustion model engine, comprising:
a) a supercharger, comprising:
i. a turbo housing, having a plurality of sides, an air intake and an air output port;
ii. a turbo impeller located within the turbo housing;
iii. a turbo shaft, a first end of which is fixedly connected to the turbo impeller and a second end of which projects through a side of the turbo housing;
iv. a means for causing the turbo shaft to rotate within the turbo housing, whereby positive air pressure is generated at the air output port;
b) a means for conveying positive air pressure from the air output port to an air intake of said internal combustion engine;
c) a means for conveying positive air pressure from the air output port to an air inlet of a pressurized fuel cell;

9. The boosting mechanism of claim 8, further comprising a means for fixedly mounting the supercharger to the engine.

10. The boosting mechanism of claim 8, wherein the means for causing the turbo shaft to rotate comprises:
a) a turbo pulley fixedly connected to the second end of the turbo shaft;
b) a drive pulley fixedly attached to a drive shaft of the engine; and
c) a drive belt engaged with the engine pulley and the turbo pulley wherein the drive belt rotates the turbo pulley in response to the rotation of the engine pulley.

11. The boosting mechanism of claim 8, further comprising a filter means.

12. The boosting mechanism of claim 11 wherein the filter means is attached to the turbo housing air intake.

13. The boosting mechanism of claim 8 wherein the means for conveying positive air pressure from the air output port to the air inlet of the pressurized fuel cell comprises flexible tubing.

14. The boosting mechanism of claim 8 wherein the means for conveying positive air pressure from the air output port to the air intake of said internal combustion engine comprises flexible tubing.

15. The boosting mechanism of claim 13 wherein the flexible tubing further comprises a one way valve between the air output port and the air inlet of the pressurized fuel cell, such that air flow from the fuel cell air inlet to the air output port is prevented.

16. The boosting mechanism of claim 9 wherein the means for mounting the supercharger to the engine comprises a mounting bracket that is capable of attachment to differently spaced mounting holes.

17. A kit of parts for a boosting mechanism capable of retrofitting an internal combustion model engine, comprising:
a) a supercharger;
b) a mounting bracket for attaching the supercharger to the engine;
c) an engine pulley for attaching to the engine drive shaft;
d) a drive belt for transferring rotational energy from the engine pulley to the supercharger;
e) a tube for conveying air pressure from the supercharger to the engine's air intake; and
f) a tube for conveying air pressure from the supercharger to the engine's fuel cell.

18. A fuel pressure boosting system for an internal combustion model engine comprising: a pressurized fuel cell;
a) a source of positive air pressure;
b) a means for conveying positive air pressure from the source of positive air pressure to an air inlet of the pressurized fuel cell.

19. The fuel pressure boosting system of claim 18, wherein the means for conveying positive air pressure from the source of positive air pressure to the air inlet of the pressurized fuel cell further comprises a one way valve between the source of positive air pressure and the fuel cell to prevent air flow from the fuel cell to the source of positive air pressure.

20. The fuel pressure boosting system of claim 19, wherein the source of positive air pressure is engine exhaust.
